(19) United States
(12) Patent Application Publication
(10) Pub. No.: US 2026/0236171 A1
(43) Pub. Date: Aug. 13, 2026

(54) DATA TRANSMISSION METHOD, DEVICE AND SYSTEM, AND STORAGE MEDIUM

(71) Applicant: CLOUD INTELLIGENCE ASSETS HOLDING (SINGAPORE) PRIVATE LIMITED, Singapore (SG)

(72) Inventor: Shuguang CHENG, Hangzhou, Zhejiang (CN)

(21) Appl. No.: 19/156,760

(22) PCT Filed: Jan. 31, 2024
(86) PCT No.: PCT/CN2024/074831

§ 371 Date: Aug. 14, 2025

(30) Foreign Application Priority Data
Feb. 27, 2023 (CN) 202310206647.9

(51) Int. Cl. G06F 3/06; G06F 13/28

(52) U.S. Cl. CPC G06F 3/0611; G06F 3/0658; G06F 13/28

(57) ABSTRACT

Embodiments of this application provide a data transmission method, device and system, and a storage medium. A processor in a data processing unit may send a data input/output request for a memory in a physical machine to a programmable logic device, and the programmable logic device may perform data transmission between the memory in the physical machine and a specified storage server. In addition, the programmable logic device may also take on input/output condition check work that was originally required to be performed by the processor. In this way, the programmable logic device directly completes data transmission and related check work, so that an internal transmission delay within the data processing unit can be effectively reduced, and a network bandwidth supported by the data processing unit is no longer limited by a bus bandwidth between the processor and the programmable logic device in the data processing unit.

### CROSS-REFERENCE TO RELATED APPLICATIONS

This application is a national stage of International Application No. PCT/CN2024/074831, filed on Jan. 31, 2024, which claims priority to Chinese Patent Application No. 202310206647.9 field with the China National Intellectual Property Administration on Feb. 27, 2023 and entitled “DATA TRANSMISSION METHOD, DEVICE AND SYSTEM, AND STORAGE MEDIUM”. Both of the aforementioned applications are incorporated herein by reference in their entireties.

### TECHNICAL FIELD

This application relates to the field of cloud computing technologies, and in particular, to a data transmission method, device and system, and a storage medium.

### BACKGROUND

With continuous increase in network bandwidths, a network bandwidth used for a data center of cloud computing has reached 100 G, and even 200 G/400 G, but a development speed of performance of a CPU of a cloud server in the data center is far lower than a development speed of the network bandwidth, leading to a prominent bottleneck of the performance of the CPU.

At present, hardware devices such as an intelligent network card, a data processing unit (DPU), or an infrastructure processing unit (IPU), are added to the cloud server in more and more data centers to perform I/O acceleration on the cloud server.

However, in a process of performing I/O acceleration on the cloud server, data migration needs to be performed a plurality of times between internal components of the hardware devices, leading to a relatively high transmission delay inside the data processing unit. As a result, an I/O acceleration effect on the cloud server is still insufficient.

### SUMMARY

A plurality of aspects of this application provide a data transmission method, device and system, and a storage medium, to improve an I/O acceleration effect on a physical machine.

An embodiment of this application provides a data transmission method, applied to a data processing unit, where the data processing unit is assembled on a physical machine, the data processing unit includes a processor and a programmable logic device, and the method includes:
sending, by the processor, a data input request to the programmable logic device, where the data input request indicates to transmit first data in a first storage server to a memory of the physical machine;
obtaining, by the programmable logic device, according to the data input request, a response packet containing the first data from the first storage server; and
writing, by the programmable logic device, the first data into the memory of the physical machine in a case of determining that the response packet meets an input condition.

An embodiment of this application further provides a data transmission method, applied to a data processing unit, where the data processing unit is assembled on a physical machine, the data processing unit includes a processor and a programmable logic device, and the method includes:
sending, by the processor, a data output request to the programmable logic device, where the data output request indicates to transmit target data in a memory of the physical machine to a specified storage server;
reading, by the programmable logic device, the target data from the memory of the physical machine according to the data output request; and
sending, by the programmable logic device, the target data to the specified storage server in a case of determining that the target data meets an output condition.

An embodiment of this application further provides a data processing unit, including a processor and a programmable logic device, where the processor and the programmable logic device respectively store one or more program instructions; and
the processor and the programmable logic device respectively execute the one or more program instructions stored in the processor and the programmable logic device, to perform the data transmission method described above.

An embodiment of this application further provides a data transmission system, including a physical machine, a data processing unit, and at least one storage server, where the data processing unit is assembled on the physical machine, the data processing unit is configured to store and execute program instructions, and when the program instructions are executed by the data processing unit, the data transmission method described above is implemented, to perform data transmission between a memory of the physical machine and a specified storage server in the at least one storage server.

An embodiment of this application further provides a storage medium, the storage medium including a stored program, where when the program is run, a device in which the storage medium is located is controlled to perform the data transmission method described above.

In the embodiments of this application, in a scenario in which data transmission needs to be performed between a memory in a physical machine and a specified storage server, a processor in a data processing unit may send a data input/output request for the memory in the physical machine to a programmable logic device, and the programmable logic device may perform data transmission between the memory in the physical machine and the specified storage server. In addition, the programmable logic device may also take on input/output condition check work that was originally required to be performed by the processor. In this way, in the data processing unit, data migration does not need to be performed between the programmable logic device and the processor any more, and the programmable logic device directly completes data transmission and related check work, so that an internal transmission delay within the data processing unit can be effectively reduced, and a network bandwidth supported by the data processing unit is no longer limited by a bus bandwidth between the processor and the programmable logic device in the data processing unit. Therefore, an I/O acceleration effect of the data processing unit on the physical machine can be effectively improved.

### BRIEF DESCRIPTION OF DRAWINGS

The accompanying drawings described herein are used to provide a further understanding of this application, and form a part of this application. Exemplary embodiments of this application and descriptions thereof are used for explaining this application, and do not constitute any inappropriate limitation to this application. In the accompanying drawings:

FIG. 1 is a schematic flowchart of a data transmission method according to an exemplary embodiment of this application.

FIG. 2 is a schematic logic diagram of a data input process according to an exemplary embodiment of this application.

FIG. 3 is a schematic structural diagram of a response packet according to an exemplary embodiment of this application.

FIG. 4 is a schematic logic diagram of a data output process according to an exemplary embodiment of this application.

FIG. 5 is a schematic logic diagram of a data transmission solution in an exemplary application scenario of this application.

FIG. 6 is a schematic flowchart of another data transmission method according to an exemplary embodiment of this application.

FIG. 7 is a schematic structural diagram of a data processing unit according to an exemplary embodiment of this application.

### DESCRIPTION OF EMBODIMENTS

To make the objectives, technical solutions, and advantages of this application clearer, the technical solutions in this application are clearly and completely described below with reference to specific embodiments and corresponding accompanying drawings of this application. Apparently, the described embodiments are some but not all of the embodiments of this application. Based on the embodiments of this application, all other embodiments obtained by a person of ordinary skill in the art without making creative efforts fall within the protection scope of this application.

At present, data migration needs to be performed a plurality of times between internal components of a data processing unit, leading to a relatively high transmission delay within the data processing unit. As a result, an I/O acceleration effect on a cloud server is still insufficient. Therefore, in some embodiments of this application, a data processing unit that may be assembled on a physical machine is provided, including a processor and a programmable logic device. In a scenario in which data transmission needs to be performed between a memory in the physical machine and a specified storage server, the processor may send a data input/output request for the memory in the physical machine to the programmable logic device, and the programmable logic device may perform data transmission between the memory in the physical machine and the specified storage server. In addition, the programmable logic device may also take on input/output condition check work that was originally required to be performed by the processor. In this way, in the data processing unit, data migration does not need to be performed between the programmable logic device and the processor any more, and the programmable logic device directly completes data transmission and related check work, so that an internal transmission delay within the data processing unit can be effectively reduced, and a network bandwidth supported by the data processing unit is no longer limited by a bus bandwidth between the processor and the programmable logic device in the data processing unit. Therefore, an I/O acceleration effect of the data processing unit on the physical machine can be effectively improved.

The technical solutions provided in the embodiments of this application are described in detail below with reference to the accompanying drawings.

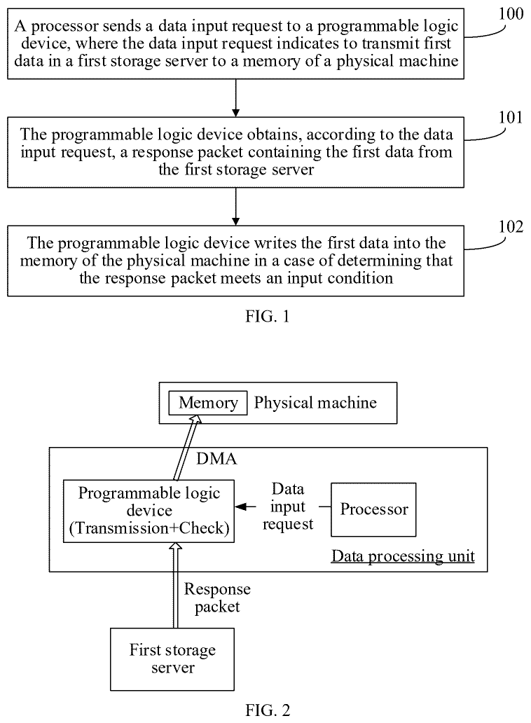

FIG. 1 is a schematic flowchart of a data transmission method according to an exemplary embodiment of this application. The method may be applied to a data processing unit.

In this embodiment, the data processing unit may include a processor and a programmable logic device. The processor and the programmable logic device may be connected through a bus or PCIE (Peripheral Component Interconnect Express). The processor may be implemented by using a system on chip (SOC), and the programmable logic device may be implemented by using a field programmable gate array (FPGA) or an application-specific integrated circuit (ASIC). Certainly, in this embodiment, the processor and the programmable logic device in the data processing unit may alternatively be implemented by using other hardware, and are not limited thereto.

The data processing unit in this embodiment may be assembled on a physical machine, and at least has a data transmission function provided in this embodiment, to perform I/O acceleration on the physical machine. An I/O acceleration technology is a technology of unloading I/O processing work that was originally required to be performed by a CPU in the physical machine to the data processing unit assembled on the physical machine. The I/O acceleration technology may effectively reduce occupation to CPU resources in the physical machine, to improve the I/O processing efficiency. It should be understood that, in addition to having the data transmission function provided in this embodiment, the data processing unit in this embodiment may further have another function, for example, an encryption and decryption function, and the another function had by the data processing unit is not limited in this embodiment.

In terms of a product form, the data processing unit in this embodiment may be implemented as a smart network card, a data processing unit (DPU), an infrastructure processing unit (IPU), or another hardware product having an I/O acceleration function in the future. The product form of the data processing unit is not limited in this embodiment.

Based on this, referring to FIG. 1, a data transmission method provided in this embodiment may include:
Step 100, a processor sends a data input request to a programmable logic device, where the data input request indicates to transmit first data in a first storage server to a memory of a physical machine.
Step 101, the programmable logic device obtains, according to the data input request, a response packet containing the first data from the first storage server.
Step 102, the programmable logic device writes the first data into the memory of the physical machine in a case of determining that the response packet meets an input condition.

In this embodiment, program instructions may be respectively stored in the processor and the programmable logic device in the data processing unit, the processor and the programmable logic device may respectively execute the program instructions stored in the processor and the programmable logic device, to perform the data transmission method provided in this embodiment.

The physical machine in this embodiment may be a cloud server, or may be a non-cloud server, for example, a physical machine used for computation in a private equipment room of an enterprise. In a case that the physical machine is a cloud server, a deployment position of the physical machine in a cloud computing architecture is not limited in this embodiment. In an embodiment, the physical machine may be any cloud server located in a computing cluster in the cloud computing architecture. A storage cluster may be further included in the cloud computing architecture. The storage cluster may be a cluster formed by a plurality of storage servers, managed as a whole logically, and may provide a storage service. By performing storage virtualization on the storage cluster, a plurality of virtual storage devices (for example, cloud disks) may be generated, where the virtual storage device may be run on the cloud server to be read, written, and used as a computer disk. The storage virtualization technology is a technology of abstracting physical storage resources into logic storage resources, to provide higher flexibility and extensibility and reduce the complexity and costs of storage management, which are not described too much herein. In addition, in this case, one or more virtual machines may be further run on the physical machine, an application program may be run in the virtual machine, and a process corresponding to the application program may occupy the memory of the physical machine. Based on this, the virtual machine may initiate an I/O request and carry a pointed target physical address (for example, a guest physical address (GPA)) in a physical address space corresponding to the virtual storage device. In this way, the I/O request initiated by the virtual machine may be used for indicating to perform data transmission between the virtual storage device and the memory of the physical machine. In this embodiment, in Step 100, the processor may obtain the I/O request initiated by the virtual machine in the physical machine; and a storage server corresponding to the target physical address in the storage cluster may be further determined through calculation, and the data input request described above or a data output request mentioned below is generated.

In this way, the processor obtaining the I/O request initiated by the virtual machine in the physical machine mentioned in the foregoing embodiment may be used as a trigger condition for the processor to send the data input request to the programmable logic device. Certainly, in addition to this trigger condition, another trigger condition may be further supported in this embodiment to trigger the processor to send the data input request to the programmable logic device, for example, a cloud copy or backup event. This embodiment is not limited thereto.

In this embodiment, the data input request is used to indicate to transmit the first data in the first storage server to the memory of the physical machine. Corresponding to the storage cluster mentioned in the foregoing embodiment, the first storage server herein may be any storage server in the storage cluster. Certainly, in this embodiment, the first storage server may alternatively be a physical machine used for data storage in a private equipment room of an enterprise. In addition, the first storage server and the physical machine may be connected through a network. During actual application, in Step 100, the processor may carry information such as an access address of the first storage server, a data identifier of the first data, and a target memory address in the physical machine in the data input request, to indicate to transmit the first data in the first storage server to the memory of the physical machine. In an embodiment, the data input request may adopt a remote procedure call (RPC) manner. Certainly, this embodiment is not limited thereto.

FIG. 2 is a schematic logic diagram of a data input process according to an exemplary embodiment of this application.

Referring to FIG. 1 and FIG. 2, in Step 101, the programmable logic device may obtain, according to the data input request, the response packet containing the first data from the first storage server. It should be noted that, the programmable logic device in this embodiment may include a communication unit, to support a communication process between the programmable logic device and the first storage server, and the programmable logic device may perform communication with the first storage server according to an agreed communication protocol.

In Step 102, after obtaining the response packet, the programmable logic device may further determine whether the response packet meets the input condition. The programmable logic device may write the first data into the memory of the physical machine in a case of determining that the response packet meets the input condition.

The accuracy of data is a very important factor that needs to be considered for the memory of the physical machine. In a conventional data processing unit, data needs to be migrated into the processor, and checking on the input condition is performed by the processor on the data, to ensure the validity of the data. In this embodiment, after obtaining the response packet, the programmable logic device no longer migrates the response packet into the processor, but directly perform checking on the input condition on the response packet, to ensure the accuracy of the data written into the memory. In this way, the programmable logic device may directly write the first data in the response packet into the memory of the physical machine in a case of determining that the response packet meets the input condition. To reduce occupation to CPU resources in the physical machine, in this embodiment, the programmable logic device may write data into the memory of the physical machine in a direct memory access manner. The direct memory access (direct memory access, DMA) technology is a technology of directly sending data from an attached device (for example, a disk drive or external hardware) to a memory of a computer. A logic functional block (IPcore) used for direct memory access may be preconfigured in the programmable logic device in this embodiment, and the programmable logic device may implement direct memory access by calling the logic functional block.

Based on this, in this embodiment, a data processing unit that may be assembled on a physical machine is provided, including a processor and a programmable logic device. In a scenario in which data in a specified storage server needs to be transmitted to a memory of the physical machine, the processor may send a data input request to the programmable logic device, and the programmable logic device may perform data transmission between the memory in the physical machine and the specified storage server. In addition, the programmable logic device may further take on input condition check work that was originally required to be performed by the processor, to ensure the accuracy of the data in the memory. In this way, in the data processing unit, data migration does not need to be performed between the programmable logic device and the processor any more, and the programmable logic device directly completes data transmission and related check work, so that an internal transmission delay within the data processing unit can be effectively reduced, and a network bandwidth supported by the data processing unit is no longer limited by a bus bandwidth between the processor and the programmable logic device in the data processing unit. Therefore, an I/O acceleration effect of the data processing unit on the physical machine can be effectively improved.

In the foregoing or following embodiments, to implement the technical concept in which the programmable logic device takes on the input condition check work, the processor may provide a necessary check basis to the programmable logic device.

In this embodiment, the input condition may include at least one of the following sub-conditions.

### First Sub-Condition

The programmable logic device may extract packet description information from a specified field of the response packet, where the specified field is configured by the first storage server according to a specified communication protocol agreed between the first storage server and the programmable logic device.

The programmable logic device determines that the data input request meets the first sub-condition in a case of finding check rule information corresponding to the data input request and the packet description information matches the check rule information.

The programmable logic device performs communication with the first storage server according to the agreed specified communication protocol. In this embodiment, the specified field containing the packet description information in the response packet may be specified in the specified communication protocol. During actual application, the first storage server may add a protocol header to an original packet, and configure the specified field in the added protocol header. The original packet is a packet generated by the first storage server according to a case of performing communication with a conventional programmable logic device (in which data migration is performed).

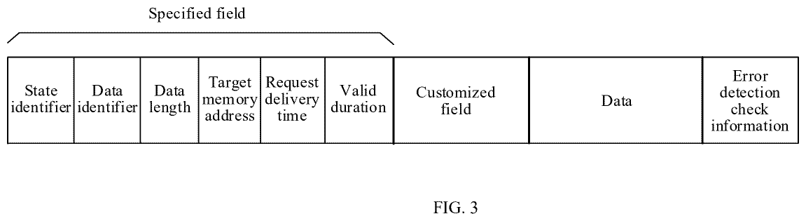

FIG. 3 is a schematic structural diagram of a response packet according to an exemplary embodiment of this application. Referring to FIG. 3, the response packet may include a protocol header corresponding to a specified communication protocol and an original packet part. Referring to FIG. 3, following the foregoing storage virtualization scenario, the original packet part may include a protocol field used for supporting a storage protocol, first data, and error detection check information. In this embodiment, an original packet is not changed, and only a specified protocol header is added to the original packet, so that the protocol field used for supporting a storage protocol is completely reserved. Therefore, the data transmission method provided in this embodiment may support various customized storage protocols and have relatively high universality. That is, a storage protocol that was originally used by the storage cluster does not need to be changed in this embodiment. In an embodiment, the foregoing storage cluster may be a distributed storage cluster, and the storage cluster may provide a storage service to the physical machine based on a distributed storage protocol. In this way, the protocol field used for supporting a storage protocol may include but is not limited to a distributed storage protocol field, an RPC protocol field, and a network transmission layer protocol field.

In this embodiment, the packet description information may include but is not limited to an identifier, a target memory address, a data length, or a state identifier used for indicating whether to directly write data into a memory of the data input request.

In addition, in this embodiment, the processor may generate check rule information for the data input request sent to the programmable logic device. The check rule information is used as a check basis of the first sub-condition. The check rule information includes but is not limited to the identifier, the target memory address, the data length, a request delivery time, or request valid duration of the data input request.

It should be noted that, in this embodiment, the processor needs to promptly send the check rule information generated for the data input request to the programmable logic device, to ensure that the programmable logic device can correctly perform checking after obtaining the response packet. In an implementation of this embodiment, the processor may send the data input request and its corresponding check rule information to the programmable logic device synchronously.

To ensure the accuracy of checking, in this embodiment, the consistency of an identifier of a same data input request may be kept among the processor, the programmable logic device, and the first storage server. The processor may further allocate an identifier for the data input request in a unique and ascending manner, to keep the uniqueness of the identifier of the data input request. The processor may further generate different data input requests for an initial transmission process and a retransmission process of same data to allocate different identifiers, to avoid an identifier from occurring repeatedly.

The programmable logic device may maintain a check rule table locally, and store check rule information respectively corresponding to different data input requests provided by the processor as entries in the check rule table, so that check rules in the check rule table are not repeated and also have uniqueness.

In addition, in this embodiment, in a case of determining that the data input request has been invalid, the processor sends a deletion instruction for the check rule information corresponding to the data input request to the programmable logic device, to enable the programmable logic device to delete the check rule information corresponding to the data input request locally. For example, if the I/O request initiated by the virtual machine in the physical machine has been canceled or the I/O request has expired, the processor may determine that the corresponding data input request has been invalid, and notify the programmable logic device in time to delete the corresponding check rule information. Through a mandatory deletion mechanism of the processor, data corresponding to the data input request that has been invalid may be prevented from being written into the memory of the physical machine, thereby ensuring the accuracy of data in the memory.

Based on this, after extracting the packet description information, the programmable logic device may locally search for whether the check rule information corresponding to the data input request exists, and if the check rule information exists, it indicates that the current data input request is valid. During actual application, the check rule may be searched for according to the identifier of the data input request. The programmable logic device may further determine whether the packet description information matches the corresponding check rule information, and if the packet description information matches the corresponding check rule information, it indicates that the response packet meets the first sub-condition. A process of determining whether the packet description information matches the check rule information may include but is not limited to:
determining whether the data length in the packet description information is consistent with the data length in the check rule information;
determining whether the target memory address in the packet description information is consistent with the target memory address in the check rule information;
calculating an invalidation time of the request according to the request delivery time and the request valid duration in the check rule information, and determining whether a reception time of the response packet exceeds the invalidation time of the request; or
whether the state identifier indicates to directly write data into a memory.

If the data lengths are inconsistent, it indicates that an error may occur in an obtaining process of the data. If the memory addresses are inconsistent, it indicates that a write address corresponding to the data in the memory may change. If the reception time exceeds the invalidation time of the request, it indicates that the response packet has been invalid due to timeout. If the state identifier indicates that the data cannot be directly written into the memory, it indicates that some extra processing may need to be performed on the data and the data should not be directly written into the memory. During actual application, in a case that any of the foregoing several determining results is a negative one, it may be determined that the packet description information does not match the check rule information.

In this embodiment, the programmable logic device may delete the check rule information locally in a case that the packet description information does not match the check rule information rule information corresponding to the data input request.

Through checking of the first sub-condition, a response packet that has been invalid or is incorrect may be accurately found, thereby avoiding a problem of a data error in the memory of the physical machine caused by such response packet.

### Second Sub-Condition

The programmable logic device may extract error detection check information from the response packet.

The programmable logic device performs error detection on the first data in the response packet based on the error detection check information.

The programmable logic device determines that the data input request meets the second sub-condition in a case that the first data passes the error detection.

The error detection check information may include but is not limited to error-correcting code (ECC) memory check information, cyclic redundancy check (CRC) information, or parity check information. During actual application, the first storage server, as a data sending end, may calculate the error detection check information for the first data and add the error detection check information to the response packet. For example, referring to a tail field in the response packet shown in FIG. 3, the field carries the error detection check information.

Through checking of the second sub-condition, a response packet that has been incomplete may be accurately found, thereby avoiding a problem of a data error in the memory of the physical machine caused by such response packet.

### Third Sub-Condition

The programmable logic device may obtain error detection check information provided by the processor for the check rule information corresponding to the data input request.

The programmable logic device performs error detection on the check rule information based on the error detection check information.

The programmable logic device determines that the data input request meets the third sub-condition in a case that the check rule information passes the error detection.

When sending the check rule information to the programmable logic device, the processor may calculate the error detection check information for the check rule information and also send the error detection check information corresponding to the check rule information to the programmable logic device. Based on this, the programmable logic device may check the integrity of the check rule information.

Through checking of the third sub-condition, a response packet whose check rule information has been incomplete may be accurately found, so that an erroneous check result generated when checking of the first sub-condition is performed on the response packet caused by an erroneous check rule information may be avoided.

In an implementation of this embodiment, the input condition may include the first sub-condition, the second sub-condition, and the third sub-condition simultaneously. In this case, the programmable logic device may determine that the response packet meets the input condition in a case of determining that the response packet meets the first sub-condition, the second sub-condition, and the third sub-condition simultaneously. Certainly, in this embodiment, the input condition may alternatively include only some of the foregoing sub-conditions. For example, the input condition may include the first sub-condition and the third sub-condition. In this case, the programmable logic device may determine that the response packet meets the input condition in a case of determining that the response packet meets the first sub-condition and the third sub-condition. For another example, the input condition may include the first sub-condition and the second sub-condition. In this case, the programmable logic device may determine that the response packet meets the input condition in a case of determining that the response packet meets the first sub-condition and the second sub-condition. A specific combination manner may be set according to an actual requirement, which is not limited in this embodiment. In addition, in this embodiment, more sub-conditions may be added in the input condition, to perform more comprehensive checking on the response packet, thereby improving the accuracy of data in the memory of the physical machine.

As mentioned above, the programmable logic device may write the first data in the response packet into the memory of the physical machine in a case of determining that the response packet meets the input condition. Specifically, the first data may be written into the target memory address carried in the data input request. In addition, after writing the first data into the memory, the programmable logic device may delete the check rule information corresponding to the data input request locally, to ensure the check accuracy of a subsequent data input request.

So far, the programmable logic device completes data transmission work of transmitting the first data in the first storage server to the memory of the physical machine.

In addition, the programmable logic device may stop an operation of writing the first data in the response packet into the memory of the physical machine in a case of determining that the response packet does not meet the input condition. During actual application, in this case, the programmable logic device may send the response packet to the processor according to data migration logic of a conventional data processing unit, the processor determines whether the response packet may be written into the memory, and if yes, the processor may migrate the first data in the response packet back to the programmable logic device and control the programmable logic device to write the first data into the memory of the physical machine. That is, in a case of determining that the obtained response packet does not meet the input condition, the programmable logic device may process the response packet according to the data migration logic of the conventional data processing unit.

Further, in this embodiment, the processor may further determine whether the first data written by the programmable logic device into the memory of the physical machine meets a valid condition, and if yes, the processor may send a valid instruction for the first data to the physical machine, to enable the memory of the physical machine to validate the first data. It should be understood that, after the programmable logic device writes the first data into the memory of the physical machine, the memory of the physical machine does not immediately validate the first data but needs to validate the first data after receiving the valid instruction from the processor. In this way, through double checking of the programmable logic device and the processor, the accuracy of the data in the memory of the physical machine may be further ensured.

Following the storage virtualization scenario mentioned in the foregoing embodiments, the programmable logic device may extract a protocol field used for supporting a storage protocol from the response packet; and send the extracted protocol field to the processor; and the processor may send a valid instruction for the first data to the memory in a case of determining that the protocol field meets a specified requirement, to enable the memory to validate the first data. Through checking of the processor on the protocol field, the accuracy of the original packet part in the response packet may be ensured, and the accuracy of the data in the memory of the physical machine may be further ensured.

Based on the above, in this embodiment, the programmable logic device may check the response packet from a plurality of aspects, to ensure the validity of the response packet and the integrity of data. In this way, the programmable logic device no longer needs to migrate the data to the processor for checking, the processor only needs to provide a required related check basis used for supporting check work performed by the programmable logic device to the programmable logic device. In addition, the programmable logic device may further send a non-checked part in the response packet to the processor, and the processor checks the part. In this way, through double checking of the programmable logic device and the processor, a same or even better check effect may be achieved compared to the data migration logic of the conventional data processing unit, thereby ensuring the accuracy of the data in the memory of the physical machine.

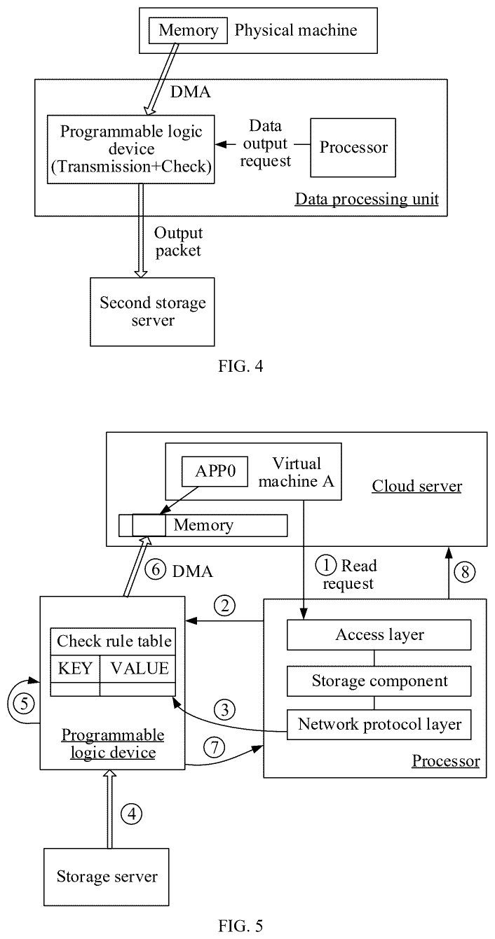

In the foregoing or following embodiments, the processor may further send a data output request to the programmable logic device, where the data output request indicates to transmit second data in the memory of the physical machine to a second storage server. FIG. 4 is a schematic logic diagram of a data output process according to an exemplary embodiment of this application.

Referring to FIG. 4, the programmable logic device may read the second data from the memory of the physical machine according to the data output request. In an implementation of this embodiment, the programmable logic device may read the second data from the memory of the physical machine in a direct memory access manner. It should be noted that, in this embodiment, the physical machine may allow, by default, the programmable logic device to read the data in the memory. This is mainly because that no data error problem may be caused in the memory when the programmable logic device reads the data in the memory. Therefore, in this embodiment, for the data output request, the programmable logic device does not need to perform check work from a plurality of aspects before accessing the memory as for the data input request any more, but may directly read the second data from the memory of the physical machine when receiving the data output request.

Referring to FIG. 4, the programmable logic device may send the second data to the second storage server in a case of determining that the second data meets an output condition. In this embodiment, the processor may provide a check basis used for performing output condition checking to the programmable logic device. In an embodiment, the processor may send data description information corresponding to the data output request to the programmable logic device, where the data description information is used for describing the second data, and the data description information may include but is not limited to a data identifier, a target memory address, or a data length. The programmable logic device determines that the second data meets the output condition in a case that the second data matches the data description information. For example, it may be determined that the second data matches the data description information in a case of determining that a memory address corresponding to the second data is consistent with the target memory address in the data description information and a data length of the second data is consistent with the data length in the data description information. Certainly, in this embodiment, the data description information may further include other information, to perform more comprehensive checking on the second data.

In this embodiment, an implementation of sending the second data to the second storage server may be determined according to an actual application scenario. Following the foregoing storage virtualization scenario, the programmable logic device may obtain, from the processor, a protocol field that is used for supporting a storage protocol and corresponds to the data output request; construct an output packet according to the second data and the protocol field; and the programmable logic device sends the output packet to the second storage server. In this process, the programmable logic device may further perform integrity checking on the obtained protocol field, and send out the constructed output packet in a case that the protocol field meets an integrity requirement, to avoid an error in a process that the protocol field is sent from the processor to the programmable logic device. In an embodiment, the processor may send error detection check information corresponding to the protocol field used for supporting a storage protocol to the programmable logic device; the programmable logic device performs error detection on the protocol field based on the error detection check information; and the programmable logic device determines that the protocol field meets the integrity requirement in a case that the protocol field passes the error detection.

In addition, in this embodiment, the programmable logic device may further calculate error detection check information for the second data; and configure the error detection check information corresponding to the second data in the output packet. In this way, after receiving the output packet, the second storage server may perform error check on the second data based on the error detection check information in the output packet, to ensure the integrity and accuracy of the second data.

Based on the above, in this embodiment, in a scenario that the memory of the physical machine outputs data to a storage server, the programmable logic device in the data processing unit is also responsible for data transmission and related check work without migrating the data to the processor for checking. The processor only needs to provide related check basis used for supporting check work performed by the programmable logic device to the programmable logic device. Therefore, in the data processing unit, data migration does not need to be performed between the programmable logic device and the processor any more, and the programmable logic device directly completes data transmission and related check work, so that an internal transmission delay within the data processing unit can be effectively reduced, and a network bandwidth supported by the data processing unit is no longer limited by a bus bandwidth between the processor and the programmable logic device in the data processing unit. Therefore, an I/O acceleration effect of the data processing unit on the physical machine can be effectively improved.

FIG. 5 is a schematic logic diagram of a data transmission solution in an exemplary application scenario of this application.

Referring to FIG. 5, an application program APPO that is run on a virtual machine A in a cloud server is used as an example, and a process corresponding to APPO occupies a part of a memory in the cloud server as a disk cache corresponding to APPO. A virtual storage device is further run on the cloud server as a disk on the cloud server. In a running process of APPO, the virtual machine A may initiate an I/O request, to indicate to perform data transmission between the memory of the cloud server and the virtual storage device. The virtual storage device is generated by performing storage virtualization on a storage cluster, so that data transmission performed between the memory of the cloud server and the virtual storage device is actually data transmission performed between the memory of the cloud server and the storage cluster. An example in which the processor in a data processing unit is implemented as an SOC chip and the programmable logic device is implemented as an FPGA is used.

In a case that the virtual machine A initiates a read request (corresponding to an input request in the I/O request)
1. The read request of the virtual machine A is delivered to the SOC chip, where the read request carries metadata information such as a physical address GPA in a physical address space and a data length (data migration does not occur).
2. The SOC chip sends an RPC request (that is, a data input request) to the FPGA.
3. Create an entry (that is, check rule information) for the RPC request, and send the entry to the FPGA, for the FPGA to add the entry to a locally maintained check rule table (in a format of key-value).
4. The FPGA obtains a response packet according to the RPC request, and parses packet description information from a specified field (configured according to a specified communication protocol, and corresponding to the specified protocol header in FIG. 5) in the response packet.
5. The FPGA performs table look-up matching according to the packet description information.
6. When matching succeeds, write data contained in the response packet to the memory of the cloud server in a DMA manner, and delete a corresponding entry.
7. The FPGA extracts a protocol field (corresponding to the customized protocol field in FIG. 5) used for supporting a storage protocol from the response packet and sends the protocol field to the SOC chip; and the SOC chip checks the protocol field, for example, a network protocol layer in the SOC checks the correctness of a network protocol field, and a storage component checks whether a CRC check result provided by the FPGA is a success.
8. The SOC chip sends a data valid instruction to the memory of the cloud server in a case of determining that checking on the protocol field succeeds, and completes the read request.

In a case that the virtual machine A initiates a write request (corresponding to an output request in the I/O request)
1. The virtual machine A delivers the write request to the SOC chip, where the write request carries metadata information such as a target memory address and a data length (data migration does not occur).
2. A storage component and a network protocol layer in the SOC chip forms a data output request according to the target memory address and the data length.
3. The SOC chip sends the data output request to the FPGA, the FPGA pulls a protocol field used for supporting a storage protocol from the SOC chip, reads data from a memory of a host in a DMA manner, and constructs a complete network packet.
4. The FPGA calculates CRC code for the data read from the memory, calculates error detection check information such as checksum for the pulled protocol field, and adds the error detection check information to the network packet.
5. After performing integrity check on the network packet, the FPGA sends the network packet to a backend storage cluster.

It may be learned from the foregoing application scenario examples that, in the data transmission method provided in this embodiment, data migration does not need to be performed within the data processing unit any more, but the programmable logic device in the data processing unit completes data transmission and related check work, and the programmable logic device may directly perform data transmission between the memory of the cloud server and the storage server in a direct memory access manner, which can greatly reduce a transmission delay within the data processing unit, thereby effectively improving I/O acceleration performance on the cloud server.

FIG. 6 is a schematic flowchart of another data transmission method according to an exemplary embodiment of this application. Referring to FIG. 6, the method is applied to a data processing unit, the data processing unit may include a processor and a programmable logic device, and the method may include:
Step 600, the processor sends a data output request to the programmable logic device, where the data output request indicates to transmit target data in a memory of a physical machine to a specified storage server.
Step 601, the programmable logic device reads the target data from the memory of the physical machine according to the data output request.
Step 602, the programmable logic device sends the target data to the specified storage server in a case of determining that the target data meets an output condition.

In an embodiment, the physical machine is any cloud server in a computing cluster, and a first storage server is any storage server in a storage cluster; and a virtual machine and a virtual storage device are run on the physical machine, the virtual storage device is generated by performing storage virtualization on the storage cluster, and the method may further include:
obtaining, by the processor, a write request initiated by the virtual machine in the physical machine, where the write request includes a pointed target physical address in a physical address space corresponding to the virtual storage device; and
determining, by the processor, a storage server corresponding to the target physical address in the storage cluster as the first storage server.

In an embodiment, Step 602 may include:
obtaining, by the programmable logic device from the processor, a protocol field that is used for supporting a storage protocol and corresponds to the data output request;
constructing, by the programmable logic device, an output packet according to the second data and the protocol field in a case that the protocol field meets an integrity requirement; and
sending, by the programmable logic device, the output packet to a second storage server.

In an embodiment, the method may further include:
obtaining, by the programmable logic device, data description information provided by the processor for the data output request;
determining, by the programmable logic device, that the second data meets the output condition in a case that the second data matches the data description information.

In an embodiment, the method may further include:
obtaining, by the programmable logic device, error detection check information provided by the processor for the protocol field;
performing, by the programmable logic device, error detection on the protocol field based on the error detection check information; and
determining, by the programmable logic device, that the protocol field meets the integrity requirement in a case that the protocol field passes the error detection.

In an embodiment, the method may further include:
calculating, by the programmable logic device, error detection check information for the second data; and
configuring the error detection check information corresponding to the second data in the output packet.

It should be understood that, the data transmission method provided in this embodiment is mainly to describe a technical solution from a data input process, and for specific technical details, reference may be made to the related description in the foregoing embodiments. Details are not described herein again.

It should be noted that, some procedures described in the foregoing embodiments and the accompanying drawings include a plurality of operations performed in a particular sequence. However, it should be clearly learned that these operations may not be performed in the sequence in which these operations are performed in the specification or may be performed concurrently. Sequence numbers, such as 101 and 102, of the operations are merely used to distinguish different operations, and the sequence numbers do not represent any execution sequence. In addition, the procedures may include more or fewer operations, and the operation may be performed in sequence or may be performed concurrently. It should be noted that, the description such as “first” and “second” in this specification is used for distinguishing different data or devices, and does not indicate a sequence, and also does not define that “first” and “second” are different types.

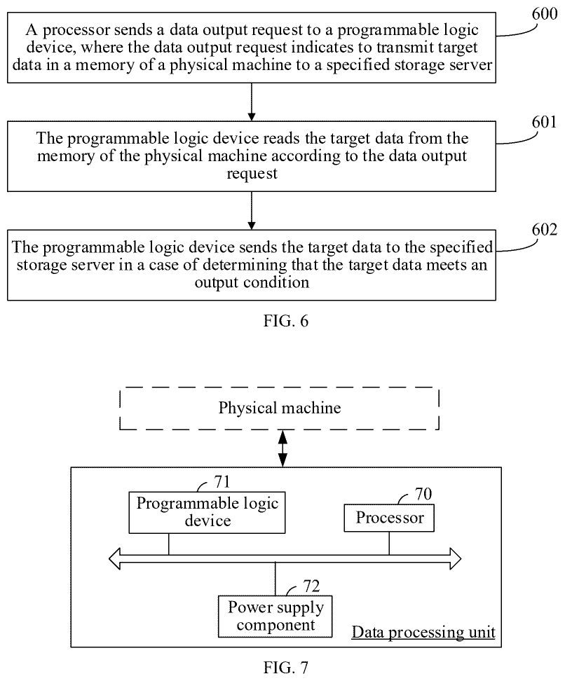

FIG. 7 is a schematic structural diagram of a data processing unit according to an exemplary embodiment of this application. As shown in FIG. 7, the data processing unit includes: a processor 70 and a programmable logic device 71, where the processor 70 and the programmable logic device 71 respectively store one or more program instructions; and
the processor 70 and the programmable logic device 71 respectively execute the one or more program instructions stored in the processor and the programmable logic device, to perform the following steps:
sending, by the processor 70, a data input request to the programmable logic device 71, where the data input request indicates to transmit first data in a first storage server to a memory of a physical machine;
obtaining, by the programmable logic device 71, according to the data input request, a response packet containing the first data from the first storage server; and
writing, by the programmable logic device 71, the first data into the memory of the physical machine in a case of determining that the response packet meets an input condition.

In an embodiment, the programmable logic device 71 may be further configured to: extract packet description information from a specified field of the response packet, where the specified field is configured by the first storage server according to a specified communication protocol agreed between the first storage server and the programmable logic device 71; and
determine that the data input request meets the input condition in a case of finding check rule information corresponding to the data input request and the packet description information matches the check rule information, where
the check rule information corresponding to the data input request is generated and sent by the processor 70 to the programmable logic device 71.

In an embodiment, the packet description information includes one or more pieces of information of an identifier, a target memory address, and a data length of the data input request.

In an embodiment, the programmable logic device 71 may be further configured to delete the check rule information corresponding to the data input request locally in a case of determining that the packet description information does not match the check rule information or after writing the first data into the memory.

In an embodiment, the processor 70 may be further configured to send, in a case of determining that the data input request has been invalid, a deletion instruction for the check rule information corresponding to the data input request to the programmable logic device 71, to enable the programmable logic device 71 to delete the check rule information corresponding to the data input request locally, where
the check rule information includes one or more pieces of information of an identifier, a target memory address, a data length, a request delivery time, and request valid duration of the data input request.

In an embodiment, the programmable logic device 71 may be specifically configured to:

extract error detection check information from the response packet;
perform error detection on the first data in the response packet based on the error detection check information; and
determine that the data input request meets the input condition in a case of finding the check rule information corresponding to the data input request, the packet description information matches the check rule information, and the first data passes the error detection.

In an embodiment, the programmable logic device 71 may be specifically configured to:
obtain error detection check information provided by the processor 70 for the check rule information corresponding to the data input request;
perform error detection on the check rule information based on the error detection check information; and
determine that the data input request meets the input condition in a case of finding the check rule information corresponding to the data input request, the packet description information matches the check rule information, and the check rule information passes the error detection.

In an embodiment, the physical machine is any cloud server in a computing cluster, and the first storage server is any storage server in a storage cluster; and a virtual machine and a virtual storage device are run on the physical machine, the virtual storage device is generated by performing storage virtualization on the storage cluster, and the processor 70 may be configured to:
obtain a read request initiated by the virtual machine in the physical machine, where the read request includes a pointed target physical address in a physical address space corresponding to the virtual storage device; and
determine a storage server corresponding to the target physical address in the storage cluster as the first storage server.

In an embodiment, the programmable logic device 71 may be further configured to: extract a protocol field used for supporting a storage protocol from the response packet; and send the extracted protocol field to the processor 70; and
the processor 70 may be further configured to send a valid instruction for the first data to the memory in a case of determining that the protocol field meets a specified requirement, to enable the memory to validate the first data written by the programmable logic device 71.

In an embodiment, the processor 70 may be further configured to send a data output request to the programmable logic device 71, where the data output request indicates to transmit second data in the memory of the physical machine to a second storage server; and
the programmable logic device 71 may be further configured to: read the second data from the memory of the physical machine according to the data output request; and send the second data to the second storage server in a case of determining that the second data meets an output condition.

In an embodiment, the programmable logic device 71 may be further configured to: obtain, from the processor 70, a protocol field that is used for supporting a storage protocol and corresponds to the data output request; construct an output packet according to the second data and the protocol field in a case that the protocol field meets an integrity requirement; and send the output packet to the second storage server.

In an embodiment, the programmable logic device 71 may be further configured to: obtain data description information provided by the processor 70 for the data output request; and determine that the second data meets the output condition in a case that the second data matches the data description information.

In an embodiment, the programmable logic device 71 may be further configured to: obtain error detection check information provided by the processor 70 for the protocol field; perform error detection on the protocol field based on the error detection check information; and determine that the protocol field meets the integrity requirement in a case that the protocol field passes the error detection.

In an embodiment, the programmable logic device 71 may be further configured to: calculate error detection check information for the second data; and configure the error detection check information corresponding to the second data in the output packet.

Further, as shown in FIG. 7, the data processing unit further includes another component such as a power supply component 72. FIG. 7 only exemplarily shows some components, and does not mean that the data processing unit only includes the components shown in FIG. 7.

It should be noted that, for technical details in the embodiments of the data processing unit, reference may be made to the related description in the foregoing method embodiments, and details are not described herein for brevity. However, this should not cause a loss to the protection scope of this application.

An embodiment of this application further provides a data transmission system, including a physical machine, a data processing unit, and at least one storage server, where the data processing unit is assembled on the physical machine, the data processing unit is configured to store and execute program instructions, and when the program instructions are executed by the data processing unit, the steps in the foregoing method embodiments are implemented, to perform data transmission between a memory of the physical machine and a specified storage server in the at least one storage server.

Correspondingly, an embodiment of this application further provides a computer-readable storage medium having a computer program stored therein, where when the computer program is executed, the steps in the foregoing method embodiments can be implemented.

A person skilled in the art should understand that the embodiments of this application may be provided as a method, a system, or a computer program product. Therefore, this application may adopt a form of hardware-only embodiments, software-only embodiments, or embodiments combining software and hardware. Moreover, this application may adopt a form of a computer program product that is implemented on one or more computer-usable storage media (including but not limited to a disk memory, a CD-ROM, an optical memory, and the like) that include computer-usable program code.

This application is described with reference to flowcharts and/or block diagrams of the method, the device (system), and the computer program product according to the embodiments of this application. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the computer or the processor of another programmable data processing device.

These computer program instructions may alternatively be stored in a computer-readable memory that can instruct a computer or another programmable data processing device to work in a specific mode, so that the instructions stored in the computer-readable memory generate an artifact that includes an instruction apparatus. The instruction apparatus implements functions specified in one or more procedures in the flowcharts and/or one or more blocks in the block diagrams.

These computer program instructions may alternatively be loaded onto a computer or another programmable data processing device, so that a series of operation steps are performed on the computer or the another programmable device, thereby generating computer-implemented processing. Therefore, the instructions executed on the computer or the another programmable device provide steps for implementing functions specified in one or more procedures in the flowcharts and/or one or more blocks in the block diagrams.

In a typical configuration, a computing device includes one or more processors (CPUs), an input/output interface, a network interface, and a memory.

The memory may include a form such as a volatile memory, a random access memory (RAM), and/or a non-volatile memory such as a read-only memory (ROM) or a flash memory (flash RAM) in a computer-readable medium. The memory is an example of the computer-readable medium.

The computer-readable medium includes a non-volatile medium and a volatile medium, a removable medium and a non-removable medium, which may implement storage of information by using any method or technology. The information may be computer-readable instructions, a data structure, a module of a program, or other data. Examples of a storage medium of a computer include, but are not limited to, a phase-change memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, tape and disk storage or another magnetic storage device or any other non-transmission medium that may be configured to store information that a computing device can access. According to the definitions in this specification, the computer-readable medium does not include transitory computer-readable media (transitory media), such as a modulated data signal and a carrier.

It should be further noted that, the terms “include”, “contain”, or any variants thereof are intended to cover non-exclusive inclusion. Therefore, a process, a method, an article, or a device that includes a series of elements not only includes such elements, but also includes other elements that are not clearly listed, or may include inherent elements of the process, the method, the article, or the device. Without more limitation, the element defined by a phrase “including one” does not exclude other same elements in the process, the method, the article, or the device that includes the element.

The foregoing only describes the embodiments of this application and is not intended to limit this application. For a person skilled in the art, this application may have various modifications and changes. Any modification, equivalent replacement, or improvement made without departing from the spirit and principle of this application shall fall within the protection scope of this application.

1. A data transmission method, applied to a data processing unit, wherein the data processing unit is assembled on a physical machine, the data processing unit comprises a processor and a programmable logic device, and the method comprises:
sending, by the processor, a data input request to the programmable logic device, wherein the data input request indicates to transmit first data in a first storage server to a memory of the physical machine;
obtaining, by the programmable logic device, according to the data input request, a response packet containing the first data from the first storage server; and
writing, by the programmable logic device, the first data into the memory of the physical machine in a case of determining that the response packet meets an input condition.

2. The method according to claim 1, wherein the method further comprises:
extracting, by the programmable logic device, packet description information from a specified field of the response packet, wherein the specified field is configured by the first storage server according to a specified communication protocol agreed between the first storage server and the programmable logic device; and
determining, by the programmable logic device, that the data input request meets the input condition in a case of finding check rule information corresponding to the data input request and the packet description information matches the check rule information, wherein
the check rule information corresponding to the data input request is generated and sent by the processor to the programmable logic device.

3. The method according to claim 2, wherein the packet description information comprises one or more pieces of information of an identifier, a target memory address, and a data length of the data input request; and the programmable logic device writes the first data into the memory of the physical machine in a direct memory access manner.

4. The method according to claim 2, further comprising:
deleting, by the programmable logic device, the check rule information corresponding to the data input request locally in a case of determining that the packet description information does not match the check rule information or after writing the first data into the memory.

5. The method according to claim 2, further comprising:
sending, by the processor, in a case of determining that the data input request has been invalid, a deletion instruction for the check rule information corresponding to the data input request to the programmable logic device, to enable the programmable logic device to delete the check rule information corresponding to the data input request locally, wherein
the check rule information comprises one or more pieces of information of an identifier, a target memory address, a data length, a request delivery time, and request valid duration of the data input request.

6. The method according to claim 2, wherein the determining, by the programmable logic device, that the data input request meets the input condition in a case of finding check rule information corresponding to the data input request and the packet description information matches the check rule information comprises:
extracting, by the programmable logic device, error detection check information from the response packet;
performing, by the programmable logic device, error detection on the first data in the response packet based on the error detection check information; and
determining, by the programmable logic device, that the data input request meets the input condition in a case of finding the check rule information corresponding to the data input request, the packet description information matches the check rule information, and the first data passes the error detection.

7. The method according to claim 2, wherein the determining, by the programmable logic device, that the data input request meets the input condition in a case of finding check rule information corresponding to the data input request and the packet description information matches the check rule information comprises:
obtaining, by the programmable logic device, error detection check information provided by the processor for the check rule information corresponding to the data input request;
performing, by the programmable logic device, error detection on the check rule information based on the error detection check information; and
determining, by the programmable logic device, that the data input request meets the input condition in a case of finding the check rule information corresponding to the data input request, the packet description information matches the check rule information, and the check rule information passes the error detection.

8. The method according to claim 1, wherein the physical machine is any cloud server in a computing cluster, and the first storage server is any storage server in a storage cluster; and a virtual machine and a virtual storage device are run on the physical machine, the virtual storage device is generated by performing storage virtualization on the storage cluster, and the method further comprises:
obtaining, by the processor, a read request initiated by the virtual machine running on the physical machine, wherein the read request comprises a target physical address to which the read request is pointed in a physical address space corresponding to the virtual storage device; and
determining, by the processor, a storage server corresponding to the target physical address in the storage cluster as the first storage server.

9. The method according to claim 8, further comprising:
extracting, by the programmable logic device, a protocol field used for supporting a storage protocol from the response packet;
sending the extracted protocol field to the processor; and
sending, by the processor, a valid instruction for the first data to the memory in a case of determining that the protocol field meets a specified requirement, to enable the memory to validate the first data written by the programmable logic device.

10. The method according to claim 1, further comprising:
sending, by the processor, a data output request to the programmable logic device, wherein the data output request indicates to transmit second data in the memory of the physical machine to a second storage server;
reading, by the programmable logic device, the second data from the memory of the physical machine according to the data output request; and
sending, by the programmable logic device, the second data to the second storage server in a case of determining that the second data meets an output condition.

11. The method according to claim 10, wherein the sending, by the programmable logic device, the second data to the second storage server comprises:
obtaining, by the programmable logic device, from the processor, a protocol field that is used for supporting a storage protocol and corresponds to the data output request;
constructing, by the programmable logic device, an output packet according to the second data and the protocol field in a case that the protocol field meets an integrity requirement; and
sending, by the programmable logic device, the output packet to the second storage server.

12. The method according to claim 11, further comprising:
obtaining, by the programmable logic device, data description information provided by the processor for the data output request;
determining, by the programmable logic device, that the second data meets the output condition in a case that the second data matches the data description information;
obtaining, by the programmable logic device, error detection check information provided by the processor for the protocol field;
performing, by the programmable logic device, error detection on the protocol field based on the error detection check information; and
determining, by the programmable logic device, that the protocol field meets the integrity requirement in a case that the protocol field passes the error detection.

13. The method according to claim 11, further comprising:
calculating, by the programmable logic device, error detection check information for the second data; and
configuring the error detection check information corresponding to the second data in the output packet.

14. (canceled)

15. A data processing unit, comprising a processor and a programmable logic device, wherein the processor and the programmable logic device respectively store one or more program instructions; and
the processor executes the one or more program instructions stored in the processor to send a data input request to the programmable logic device, wherein the data input request indicates to transmit first data in a first storage server to a memory of the physical machine; and
the programmable logic device executes the one or more program instructions stored in the programmable logic device, to:
obtain according to the data input request, a response packet containing the first data from the first storage server; and
write the first data into the memory of the physical machine in a case of determining that the response packet meets an input condition.

16. A data transmission system, comprising a physical machine, a data processing unit, and at least one storage server, wherein the data processing unit is assembled on the physical machine, the data processing unit is configured to store and execute program instructions, and when the program instructions are executed by the data processing unit, the data transmission method according to claim 1 is implemented, to perform data transmission between a memory of the physical machine and a specified storage server in the at least one storage server.

17. A non-transitory storage medium, the storage medium comprising a stored program, wherein when the program is run, a device in which the storage medium is located is controlled to perform the following steps:
sending, by a processor, a data input request to the programmable logic device, wherein the data input request indicates to transmit first data in a first storage server to a memory of the physical machine;
obtaining, by a programmable logic device, according to the data input request, a response packet containing the first data from the first storage server; and
writing, by a programmable logic device, the first data into the memory of the physical machine in a case of determining that the response packet meets an input condition.

18. The data processing unit according to claim 15, wherein the programmable logic device is configured to:
extract packet description information from a specified field of the response packet, wherein the specified field is configured by the first storage server according to a specified communication protocol agreed between the first storage server and the programmable logic device; and
determine that the data input request meets the input condition in a case of finding check rule information corresponding to the data input request and the packet description information matches the check rule information, wherein
the check rule information corresponding to the data input request is generated and sent by the processor to the programmable logic device.

19. The data processing unit according to claim 18, wherein the packet description information comprises one or more pieces of information of an identifier, a target memory address, and a data length of the data input request; and the programmable logic device writes the first data into the memory of the physical machine in a direct memory access manner.

20. The data processing unit according to claim 18, wherein the programmable logic device is configured to:
delete the check rule information corresponding to the data input request locally in a case of determining that the packet description information does not match the check rule information or after writing the first data into the memory.

21. The data processing unit according to claim 18, wherein the processor is configured to:
send, in a case of determining that the data input request has been invalid, a deletion instruction for the check rule information corresponding to the data input request to the programmable logic device, to enable the programmable logic device to delete the check rule information corresponding to the data input request locally, wherein
the check rule information comprises one or more pieces of information of an identifier, a target memory address, a data length, a request delivery time, and request valid duration of the data input request.
